(19) United States
(12) Patent Application Publication
(10) Pub. No.: US 2026/0287494 A1
(43) Pub. Date: Sep. 24, 2026

(54) GONIOMETRIC FLOW CYTOMETRY

(71) Applicant: Utah Valley University, Orem, UT (US)

(72) Inventor: Vincent M. Rossi, Payson, UT (US)

(21) Appl. No.: 19/083,680

(22) Filed: Mar. 19, 2025

(51) Int. Cl. G01N 15/1434; G01N 15/10; G01N 15/14; G01N 15/1429; G01N 15/149; G01N 21/64

(52) U.S. Cl. CPC G01N 15/1434; G01N 15/1429; G01N 15/1459; G01N 15/149; G01N 21/64; G01N 2015/1006

(57) ABSTRACT

Disclosed herein are embodiments of a goniometric flow cytometry system, which may comprise: (i) a sample flow path configured for flowing a plurality of samples through a sample plane; (ii) an input light source configured to illuminate the sample plane; (iii) a set of forward scatter (FSC) detection optics configured to direct FSC light from the sample plane to one or more image sensors and cause presentation of an FSC angular scattering field from the FSC light at the one or more image sensors; and (iv) a set of side scatter (SSC) detection optics configured to direct SSC light from the sample plane to one or more image sensors and cause presentation of an SSC angular scattering field from the SSC light at the one or more image sensors. Data captured using an embodiment of goniometric flow cytometry system may be used to identify or classify one or more samples.

### CROSS-REFERENCE TO RELATED APPLICATIONS

N/A

### BACKGROUND

Flow cytometry is used to measure physical and/or chemical characteristics of cells or particles as they pass through a fluidic system. Flow cytometry involves suspending cells in a liquid stream, directing them through a focused laser beam, and detecting light scatter and/or fluorescence emissions from the cells. These signals can provide detailed information about cell size, internal complexity, specific molecular markers, and/or other information. Flow cytometry is widely used in immunology, hematology, microbiology, and cancer research.

The subject matter disclosed and/or claimed herein is not limited to embodiments that operate only in environments such as those described above. Rather, this background is only provided to illustrate one or more example technology areas where some embodiments described herein may be practiced.

It shall be noted that the subject matter discussed in the background section should not be assumed to be prior art merely because of it being mentioned in this background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1 illustrates a conceptual representation of a system for performing goniometric flow cytometry, in accordance with one or more embodiments of the disclosed subject matter.

FIG. 2 illustrates a conceptual representation of a system for performing goniometric flow cytometry that includes fluorescence detection optics, in accordance with one or more embodiments of the disclosed subject matter.

FIG. 3 illustrates a conceptual representation of a system for performing goniometric flow cytometry that includes holographic image detection components, in accordance with one or more embodiments of the disclosed subject matter.

FIG. 4 illustrates a conceptual representation of another example system for performing goniometric flow cytometry, in accordance with one or more embodiments of the disclosed subject matter.

FIG. 5 illustrates an example flow diagram depicting acts associated with performing goniometric flow cytometry, in accordance with one or more embodiments of the disclosed subject matter.

FIGS. 6A and 6B illustrate example scatter plots showing forward scatter signal vs. side scatter signal for a flow cytometry simulation performed using a synthetic dataset.

FIG. 7 illustrates example normalized intensity scattering plots representing a forward scatter angular scattering signal and a side scatter angular scattering signal for a goniometric flow cytometry simulation performed using the synthetic dataset, in accordance with one or more embodiments of the disclosed subject matter.

FIG. 8 illustrates an example heat map depicting a 2D space generated by element-wise multiplying a forward scatter angular scattering signal with a side scatter angular scattering signal, in accordance with one or more embodiments of the disclosed subject matter.

FIG. 9 illustrates an example heat map depicting an example 2D scattering metric generated for a sample using a forward scatter angular scattering signal and a side scatter angular scattering signal, in accordance with one or more embodiments of the disclosed subject matter.

FIG. 10 illustrates a graph showing receiver operating characteristic (ROC) curves for the flow cytometry simulation and the goniometric flow cytometry simulation performed using the synthetic dataset, in accordance with one or more embodiments of the disclosed subject matter.

FIG. 11 illustrates area under the curve (AUC) charts for flow cytometry simulations and goniometric flow cytometry simulations performed using synthetic datasets, in accordance with one or more embodiments of the disclosed subject matter.

FIG. 12 depicts a simplified block diagram of a computing device/information handling system, according to one or more embodiments of the disclosed subject matter.

### DETAILED DESCRIPTION

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method, which may be implemented, at least in part, using data on a tangible computer-readable medium.

Components, or modules, shown in diagrams are illustrative of example embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or similar terms shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” “implementation(s)”, “example(s)”, “instance(s)” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

Any specific embodiment described herein is not necessarily limited strictly to the features expressly described for that specific embodiment and may also (or alternatively) include properties and/or features (e.g., ingredients, components, members, elements, parts, characteristics, attributes, and/or regions) described for one or more separate embodiments. Accordingly, the various features of a given embodiment can be combined with and/or incorporated into other embodiments described herein. Disclosure of certain features relative to a specific embodiment of the present disclosure should not be construed as limiting application or inclusion of said features to the specific embodiment. Rather, it will be appreciated that other embodiments can also include such features.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the context, the number of reported significant digits and by applying ordinary rounding techniques.

As used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

One skilled in the art shall recognize, in view of the present disclosure, that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

While examples provided herein discuss measuring cells as a sample, it shall be noted that embodiments are not so limited. One skilled in the art shall recognize that one or more embodiments may be used or adapted to be used on other types of samples.

### General Introduction

As noted above, flow cytometry is a process for measuring physical and/or chemical characteristics of cells (or other samples) as they pass through a fluidic system. The fluidic system causes cells to pass in a single-file stream through a sample plane (or interrogation point/region). An optical system collects data based on light scatter in different dimensions, typically including forward scatter (FSC) and side scatter (SSC). The FSC data may be indicative of cell size, while the SSC data may be indicative of cellular granularity or internal complexity, which may be used to classify and/or differentiate cells/samples.

Although flow cytometry is a powerful tool for analyzing characteristics of cells or other types of samples, conventional flow cytometry may be constrained in its ability to differentiate among cell populations that are similar in size and granularity/complexity. For instance, conventional flow cytometry suffers from a limited parameter space available for classification, as only two primary signals are used to distinguish cells: FSC and SSC signals. This limitation arises from the way that the signals are detected. With conventional flow cytometers, FSC and SSC signals are collected using single photodiodes or photomultiplier tubes that measure the intensity of the detected light. Because each scatter signal is effectively reduced to a single pixel of intensity data, valuable spatial and angular information about the scattered light is lost.

In some flow cytometry systems, fluorescence detection is performed in addition to FSC and SSC detection to enhance the parameter space and dimensionality available for differentiating cells/samples. However, fluorescence-based flow cytometry is not always an option due to the additional processes, equipment, and costs required for its implementation. For instance, fluorescence-based flow cytometry utilizes fluorescent reagents, such as labeled antibodies, nucleic acid stains, or viability dyes, which add costs, required instruments, and preparation time.

Embodiments herein are directed to goniometric flow cytometry systems and techniques that provide an enhanced parameter space for differentiating among cells/samples. In one or more embodiments, a goniometric flow cytometry includes (i) an input light source configured to illuminate a sample plane of a sample flow path, (ii) a set of FSC detection optics configured to direct FSC light from the sample plane to one or more image sensors, and (iii) a set of SSC detection optics configured to direct SSC light from the sample plane to the image sensor(s). The FSC detection optics may be configured to cause an FSC angular scattering field to be represented at the image sensor(s), and the SSC detection optics may be configured to cause an SSC angular scattering field to be represented at the image sensor(s). The FSC and/or the SSC scattering fields may comprise scattering patterns formed via near-field diffraction or via far-field diffraction (e.g., when imaging at the Fourier plane). The image sensor(s) may thus capture FSC and SSC angular scattering fields that preserve angular information about the scattered FSC and SSC light, which may advantageously contribute to an increased parameter space for differentiating among cells/samples.

For a given cell/sample, one or more disclosed techniques may include classifying and/or differentiating the cell/sample by using the FSC and SSC angular scattering fields captured by the image sensor(s) (when illuminating the given cell/sample) to obtain FSC and SSC angular scattering signals, respectively. The FSC and SSC angular scattering signals may be determined in various ways, such as by using a line scan of one or more azimuthal angles of the captured FSC or SSC angular scattering field, or by integrating the FSC or SSC angular scattering field with respect to azimuthal angle. The FSC and SSC angular scattering signals for the given cell/sample may then be combined to construct a 2D scattering metric for the given cell/sample. The 2D scattering metric may be constructed in various ways, such as by taking a ratio of (i) an element-wise multiplication of the FSC and SSC angular scattering signals to (ii) a sum of the FSC and SSC angular scattering signals. The 2D scattering metric may be used to generate a score for the given cell/sample, such as by integrating, across the 2D space, a difference between (i) the 2D scattering metric for the given cell/sample and (ii) an average of the one or more 2D scattering metrics for one or more other cells/samples (e.g., from the same cell/sample population). The score for the given cell/sample may then be assessed relative to one or more thresholds (e.g., determined via receiver operating characteristic (ROC) analysis, or other methods) to facilitate classification of the given cell/sample.

One or more disclosed embodiments may thus be implemented to facilitate acquisition of FSC and SSC angular scattering fields that make angular scattering information usable when classifying and/or differentiating cells or other samples. The increased parameter space afforded by the angular scattering information may contribute to increased accuracy when classifying and/or differentiating cells or other samples (e.g., using a scoring system as described herein). One or more disclosed techniques that incorporate angular scattering information into flow cytometry may be regarded as “goniometric flow cytometry” (or “GFC”) or “Fourier goniometric flow cytometry” (or “FGFC”, when the angular scattering fields are captured at the Fourier plane). In one or more implementations, GFC or FGFC may be performed in conjunction with fluorescence detection and/or other types of imaging (e.g., holographic imaging).

Having just described some of the high-level features and/or advantages associated with one or more of the disclosed embodiments, attention will now be directed to the Figures, which provide supporting illustrations for describing the disclosed embodiments.

### Example Goniometric Flow Cytometry Systems and Components

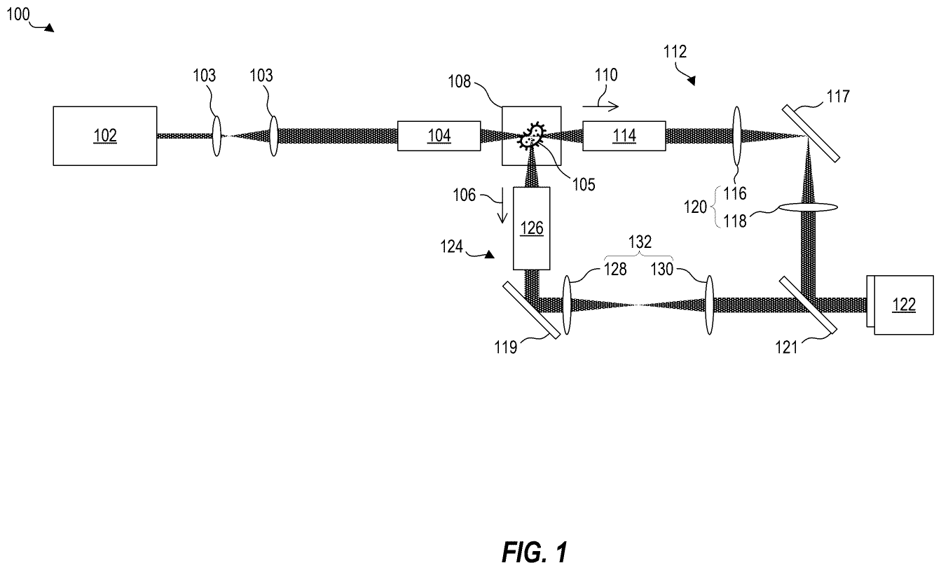

FIG. 1 illustrates a conceptual representation of a system 100 for performing FGFC, in accordance with one or more implementations of the disclosed subject matter. The system 100 illustrated in FIG. 1 includes an input light source 102 configured to illuminate a sample plane 108 of a sample flow path. From the perspective of the example shown in FIG. 1, the sample flow path may extend into and/or out of the page. The sample flow path may comprise a fluidics system that guides cells and/or other samples through a narrow, single-file stream for illumination by the input light source 102 at the sample plane 108. The cell/sample may be injected into a sheath fluid, which may hydrodynamically focus the cells into the core stream as they pass through the sample flow path. Such a system may ensure that each sample is individually exposed to light from the input light source 102 at the sample plane 108, where light scatter occurs. FIG. 1 illustrates a sample 105 flowing through the sample plane 108 that is being illuminated via light from the input light source 102.

In the example shown in FIG. 1, a condenser 104 is positioned between the input light source 102 and the sample plane 108. The condenser 104 may be adapted to focus and direct light from the input light source 102 onto the sample plane 108. The condenser 104 may comprise one or more lenses and/or mirrors that shape and concentrate the beam from the input light source 102, facilitating uniform illumination of the sample plane 108 and minimizing light loss. The condenser 104 may enhance scatter signal detection and/or overall sensitivity. When fluorescence is used, the condenser 104 may help improve excitation efficiency (e.g., causing stronger emission signals and/or improved detection accuracy).

FIG. 1 furthermore illustrates additional beamforming optics 103 intervening between the input light source 102 and the sample plane 108, indicating that any quantity of additional or alternative optics may be positioned between the input light source 102 and the sample plane 108. In one or more embodiments, no optics are implemented between the input light source 102 and the sample plane 108. In one or more examples, the condenser 104 is omitted, which may mitigate effects on angular scattering brought about by the condenser 104 causing the light from the input light source 102 to converge on the sample plane 108 and subsequently diverge.

The illumination of the sample 105 positioned at the sample plane 108 via light from the input light source 102 may cause light scatter in multiple directions. FIG. 1 depicts a forward scatter (FSC) direction 110 and a side scatter (SSC) direction 106. In the example shown in FIG. 1, the FSC direction 110 extends along the axis of the input light beam from the input light source 102 incident on the sample plane 108, and the SSC direction 106 extends perpendicular to the input light beam from the input light source 102 incident on the sample plane 108. FIG. 1 illustrates a set of FSC detection optics 112 configured to direct FSC light from the sample plane 108 in the FSC direction 110 toward an image sensor 122. FIG. 1 also illustrates a set of SSC detection optics 124 configured to direct SSC light from the sample plane 108 in the SSC direction 106 toward the image sensor 122. One will appreciate, in view of the present disclosure, that variations are possible in the FSC direction 110 at which the set of FSC detection optics 112 receive the FSC light (e.g., 0° to 10°), and that variations are possible in the SSC direction 106 at which the set of SSC detection optics 124 receive the SSC light (e.g., 70° to 110°).

In the example shown in FIG. 1, the set of FSC detection optics 112 includes an FSC 4f optical system 120, which includes lenses 116 and 118 positioned 2f apart, where f is the focal length of the lenses 116 and 118. In at least one or more embodiments, lens 118 may operate as a Fourier lens, while lens 116 may operate as a tube lens (e.g., performing an inverse Fourier transform), allowing the FSC 4f optical system 120 to cooperate with an FSC objective 114 of the set of FSC detection optics 112 to map an FSC angular scattering field onto the image sensor 122 (e.g., from the FSC objective 114). The FSC angular scattering field may include scattering angles associated with spatial frequencies of the FSC light (e.g., via far-field diffraction in the example shown in FIG. 1). The FSC 4f optical system 120 may cause the FSC angular scattering field to be represented at the image sensor 122 at the Fourier plane, which may enable efficient analysis of angular distribution. The set of FSC detection optics 112 may comprise one or more additional or alternative components, such as one or more mirrors 117 and/or one or more spatial filters (e.g., small apertures or masks) for use in conjunction with the FSC 4f optical system 120.

Similar to the set of FSC detection optics 112, FIG. 1 also illustrates the set of SSC detection optics 124 as including an SSC 4f optical system 132 including lens 128 (e.g., a tube lens) and lens 130 (e.g., a Fourier lens). FIG. 1 also illustrates the set of SSC detection optics 124 as including an SSC objective 126 configured to cooperate with the SSC 4f optical system 132 to map an SSC angular scattering field onto the image sensor 122 (e.g., from the SSC objective 126). The SSC angular scattering field may include scattering angles associated with spatial frequencies of the SSC light (e.g., via far-field diffraction in the example shown in FIG. 1). Similar to the FSC 4f optical system 120, the SSC 4f optical system 132 may cause the SSC angular scattering field to be represented at the image sensor 122 at the Fourier plane. The set of SSC detection optics 124 may include one or more additional or alternative components (e.g., one or more mirrors 119, one or more spatial filters for use in conjunction with the SSC 4f optical system 132).

As will be described in more detail hereinafter, the scattering angles represented in the FSC angular scattering field and the SSC angular scattering field represented at the image sensor 122 via the set of FSC detection optics 112 and the set of SSC detection optics 124, respectively, may be used to obtain per-sample scores or metrics for classifying and/or differentiating samples.

The set of FSC detection optics 112 and the set of SSC detection optics 124 may map the FSC angular scattering field and the SSC angular scattering field, respectively, to different regions of the same image sensor 122, as shown in the example depicted in FIG. 1 (e.g., via a beamsplitter 121). Such a configuration may enable the FSC angular scattering field and the SSC angular scattering field to be represented in different portions of the same image, which may facilitate temporal correspondence between FSC angular scattering data/signals and SSC angular scattering data/signals for the sample under analysis (e.g., sample 105). Other configurations are within the scope of the present disclosure, including but not limited to embodiments in which separate image sensors capture the FSC angular scattering signal and the SSC angular scattering signal, which may be combined into a single or composite representation.

The system 100 shown and described with reference to FIG. 1 may be used to capture angular scattering information associated with flow cytometry samples, enabling the performance of FGFC to accurately classify and/or differentiate samples (as will be described in more detail hereinafter). In accordance with the disclosed subject matter, a system for performing FGFC may incorporate additional dimensions and/or modalities of analysis, such as fluorescence and/or holography.

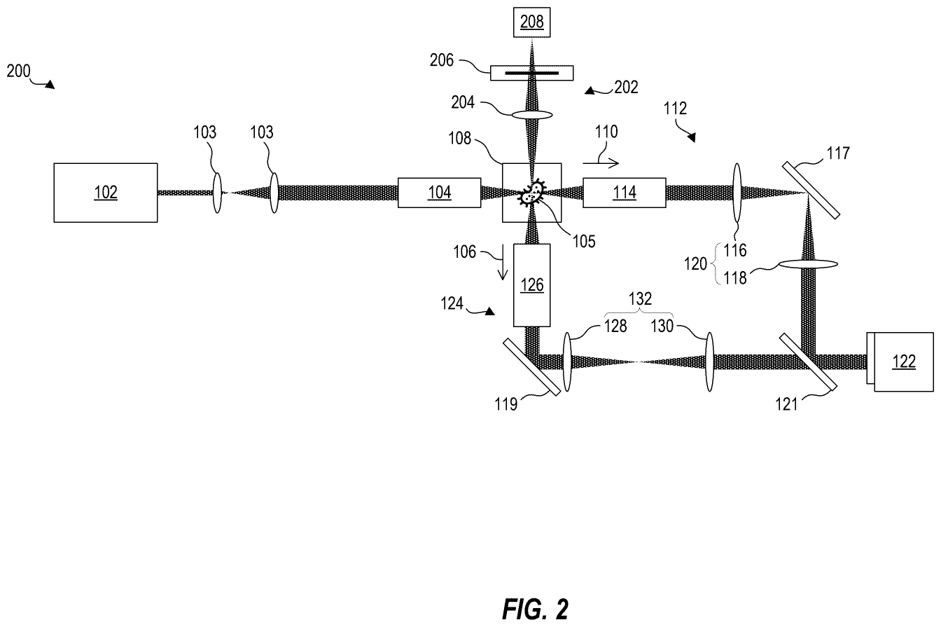

FIG. 2 illustrates a conceptual representation of a system 200 for performing FGFC that includes components similar to those described hereinabove with reference to FIG. 1 (e.g., an input light source 102, condenser 104, sample plane 108, set of FSC detection optics 112, set of SSC detection optics 124, image sensor 122, etc.). The example system 200 shown in FIG. 2 further includes a set of fluorescence detection optics 202 configured to direct a fluorescence signal from the sample plane 108 to one or more photodetectors 208 (e.g., one or more photodiodes or photomultiplier tubes). In the example shown in FIG. 2, the set of fluorescence detection optics 202 includes an objective lens 204 that may collect fluorescence emitted from the sample plane 108 and focus the fluorescence toward a filter wheel 206 (or fixed optical filters) that selectively transmit specific wavelengths to ensure that only desired fluorescence signals reach the one or more photodetectors 208. Fluorescence data acquired via the set of fluorescence detection optics 202 and the one or more photodetectors 208 may be used in conjunction with the angular scattering data captured at the image sensor 122 to facilitate classification and/or differentiation of samples/cells (as described in more detail hereinafter).

As another example, rather than using photodetector(s) 208 as illustrated in FIG. 2, a system for performing GFC can include an image sensor that receives light from the objective lens 204 to capture a fluorescent image of the sample within the sample plane 108.

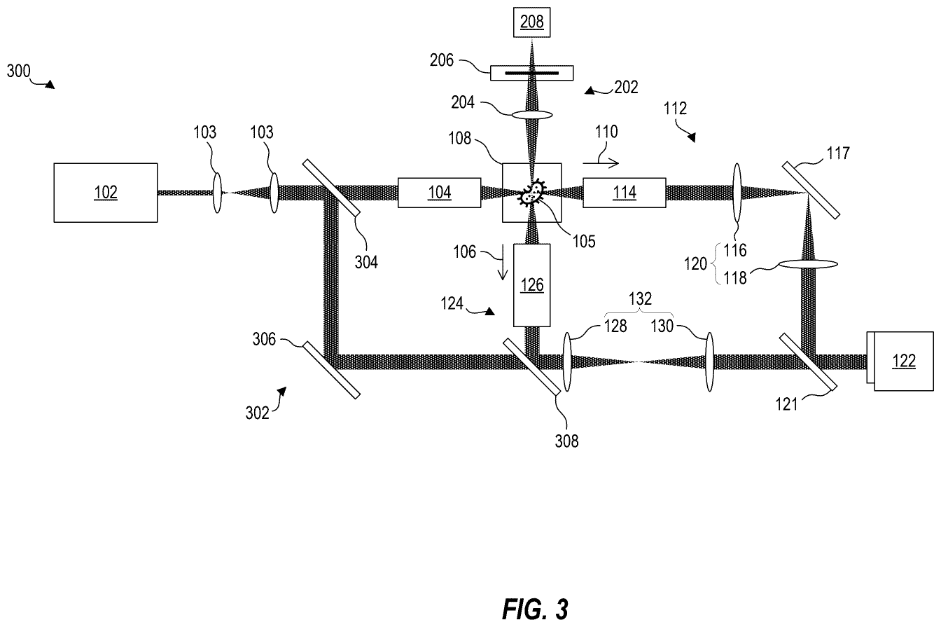

FIG. 3 illustrates a conceptual representation of a system 300 for performing FGFC that includes components similar to those described hereinabove with reference to FIGS. 1 and 2 (e.g., an input light source 102, condenser 104, sample plane 108, set of FSC detection optics 112, set of SSC detection optics 124, image sensor 122, set of fluorescence detection optics 202, one or more photodetectors 208, etc.). The example system 300 shown in FIG. 3 further includes a set of reference optics 302 that are configured to direct reference light from the input light source 102 to the image sensor 122. For instance, in the example shown in FIG. 3, the set of reference optics 302 includes a beam splitter 304 that directs some light from the input light source 102 (reference light) away from the sample plane 108 and toward a phase-shifting device 306 (e.g., a piezoelectric mirror, spatial light modulator, etc.) for modulating the phase of the reference light and directing the phase-modulated reference light toward the image sensor 122. The phase-modulated reference light may illuminate the same regions of the image sensor 122 that receive the FSC angular scattering signal and the SSC angular scattering signal (e.g., via beamsplitter 308), enabling the performance of phase-shifting holography to construct one or more holographic images of the sample under analysis (e.g., sample 105).

Although FIG. 3 illustrates the system 300 as including both the set of fluorescence detection optics 202 and the set of reference optics 302, the set of reference optics 302 may be implemented without the set of fluorescence detection optics 202 in one or more embodiments.

In the examples shown and described with reference to FIGS. 1, 2, and 3, the set of FSC detection optics 112 and the set of SSC detection optics 124 may cause the FSC angular scattering field and the SSC angular scattering field to be represented at the image sensor 122 via far-field diffraction at the Fourier plane. FSC and/or SSC angular scattering fields may be captured in other ways in accordance with the disclosed subject matter. For instance, the position of the image sensor 122 shown in FIG. 1 may be varied such that the image sensor 122 does not capture the FSC angular scattering signal and/or the SSC angular scattering signal at the Fourier plane. In one or more implementations, the beamsplitter 121 is omitted and separate image sensors are used to capture the FSC angular scattering signal and the SSC angular scattering signal. In one or more embodiments, the FSC 4f optical system 120 and/or the SSC 4f optical system 132 is/are omitted, and/or the FSC objective 114 and/or the SSC objective 126 is/are omitted, enabling one or more image sensors to be positioned at one or more points along the FSC direction 110 and/or the SSC direction 106 (which may be steered/directed) extending from the sample plane 108 to capture the FSC angular scattering field and the SSC angular scattering field.

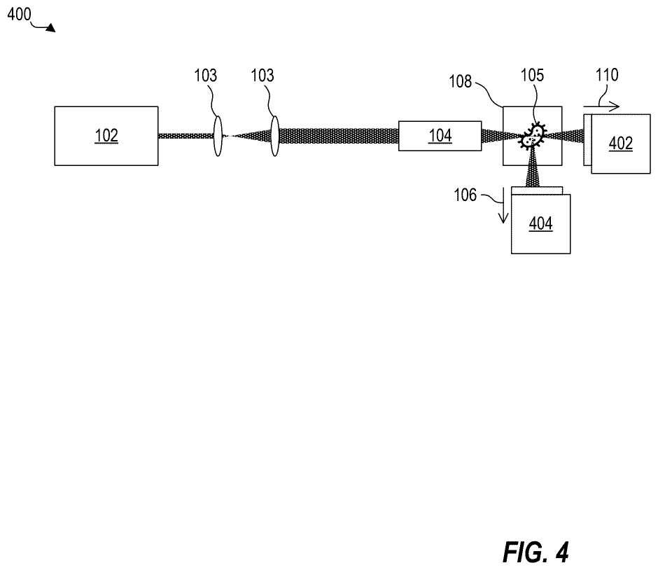

FIG. 4 illustrates an example system 400 for performing GFC that omits the FSC 4f optical system 120, the SSC 4f optical system 132, the FSC objective 114, and the SSC objective 126. The system 400 includes an image sensor 402 that receives FSC light from the sample plane 108 in the FSC direction 110 and an image sensor 404 that receives SSC light from the sample plane 108 in the SSC direction 106. The FSC light received by the image sensor 402 captures an FSC angular scattering signal via near-field diffraction, and the SSC light received by the image sensor 404 captures an SSC angular scattering signal via near-field diffraction. Although the example shown in FIG. 4 includes the condenser 104, the condenser 104 (and/or the beamforming optics 103) may be omitted from the system 400 in one or more implementations. In this regard, a system for performing GFC may include a set of optics that is configured to (i) direct FSC light to an image sensor, causing presentation of an FSC angular scattering signal at the image sensor (via near-field or far-field diffraction), and (ii) direct SSC light to the same (or a different) image sensor, causing presentation of an SSC angular scattering signal at the same (or the different) image sensor (via near-field or far-field diffraction). The set of optics may include optics upstream of the sample plane (e.g., a condenser, one or more beamforming optics, or even one or more optics internal to the input light source) and/or downstream of the sample plane (e.g., one or more objectives, one or more 4f optical systems, etc.).

### Example Method Embodiments

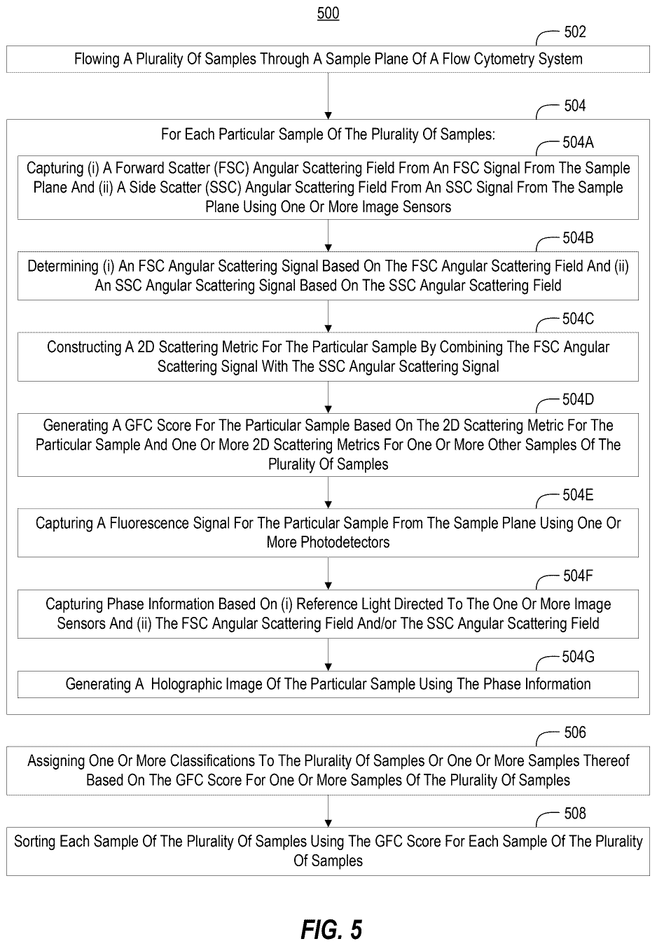

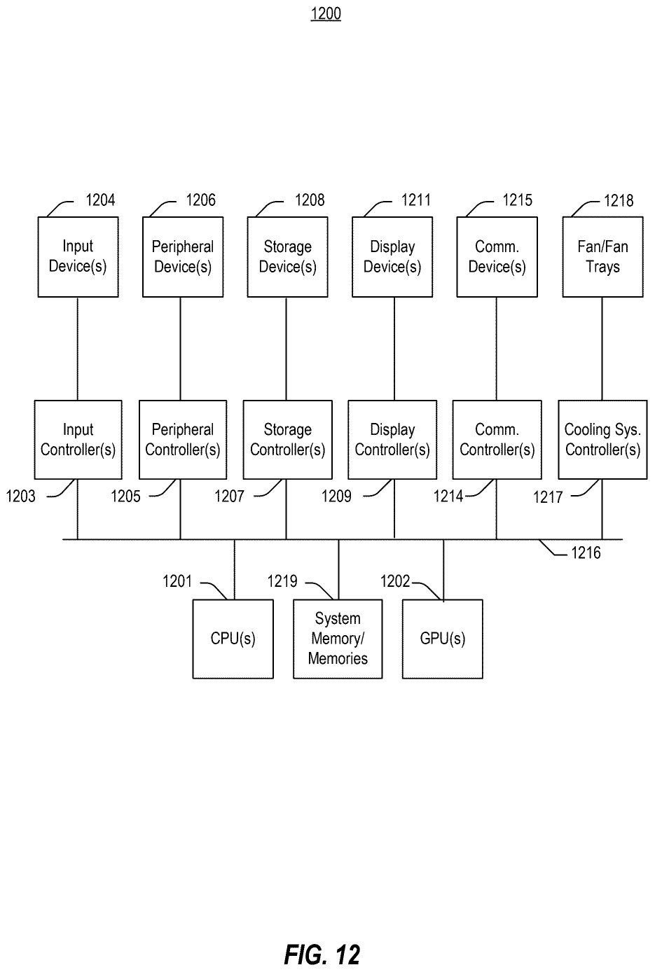

FIG. 5 illustrates an example flow diagram 500 depicting acts associated with performing GFC (or FGFC), in accordance with one or more implementations of the disclosed subject matter. As noted above, (1) certain steps may optionally be performed; (2) steps may not be limited to the specific order set forth herein; (3) certain steps may be performed in different orders; and (4) certain steps may be done concurrently. One or more acts shown and/or described with reference to flow diagram 500 may be performed using an information handling system or computing system 1200, described hereinafter with reference to FIG. 12.

Act 502 of flow diagram 500 includes flowing a plurality of samples through a sample plane of a flow cytometry system. The flow cytometry system may include components of one or more of the systems 100, 200, 300, or 400 described hereinabove with reference to FIGS. 1 through 4 (or variations thereon).

Act 504 of flow diagram 500 includes various acts that may be performed for each particular or individual sample of the plurality of samples that is flown through the sample plane of the flow cytometry system.

Act 504A of flow diagram 500 includes capturing (i) a forward scatter (FSC) angular scattering field from an FSC signal from the sample plane and (ii) a side scatter (SSC) angular scattering field from an SSC signal from the sample plane using one or more image sensors. In one or more implementations, the FSC and SSC angular scattering fields may be obtained via near-field diffraction or via far-field diffraction (e.g., captured at a Fourier plane or at another location). In one or more examples, the image sensor(s) may continuously capture images as the plurality of samples is flown through the sample plane. The difference between the current image frame and an average of a set of previous image frames may be determined. If the difference satisfies a cutoff value, a sample (e.g., the particular sample) may be regarded as detected/present in the sample plane, which may trigger analysis of the sample (e.g., using the FSC and SSC angular scattering fields) as described in subsequent acts. In another example, detection of a sample for analysis at the sample plane may be performed using other automated techniques (e.g., computer vision and/or machine learning modules) or even manually (e.g., visually by an operator).

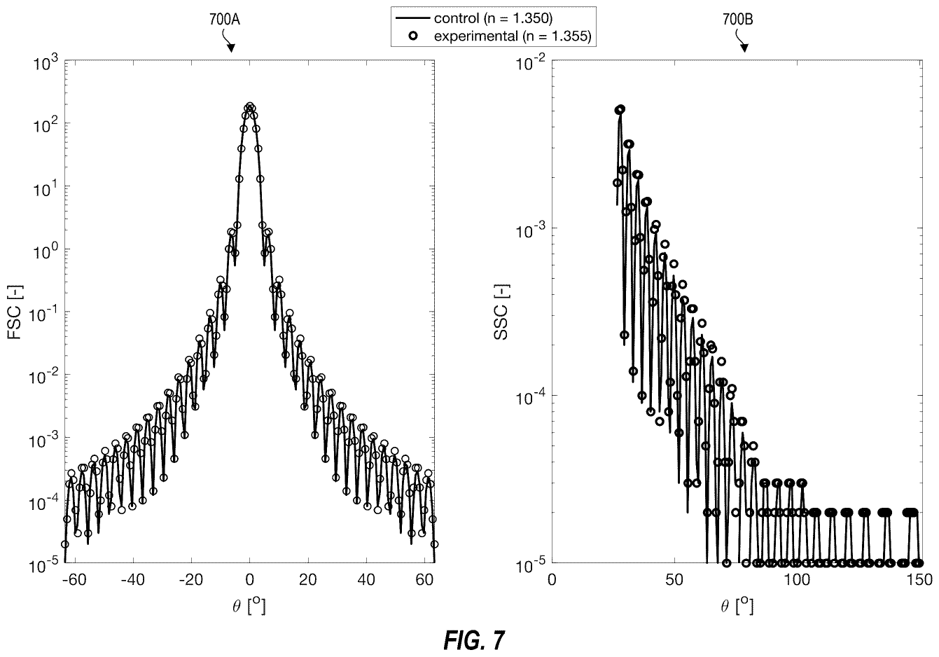

Act 504B of flow diagram 500 includes determining (i) an FSC angular scattering signal based on the FSC angular scattering field and (ii) an SSC angular scattering signal based on the SSC angular scattering field. The FSC and SSC angular scattering signals may represent how the light from a light source scatters in the forward scatter and side scatter directions, respectively, when the light interacts with the particular sample (FIG. 7 provides example normalized intensity scattering plots showing an example FSC angular scattering signal and an example SSC angular scattering signal, where the scattering angle is represented by θ). The FSC and SSC angular scattering signals may be determined or defined in various ways, such as by using a line scan (or multiple line scans) along an azimuthal angle (or multiple azimuthal angles) of the angular scattering field, or by integrating the angular scattering field with respect to azimuthal angle. The azimuthal angle (often represented by φ) indicates the rotation of the scattered wave around the incident axis, indicating the directional orientation of scattering in 3D space (whereas the scattering angle, often represented by θ, represents the angle between the incident and scattered wave, indicating the magnitude of scattering).

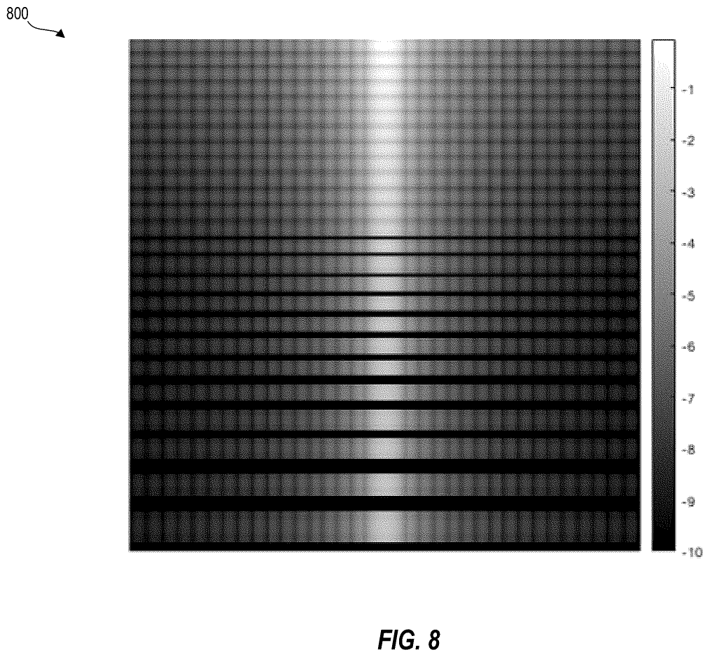

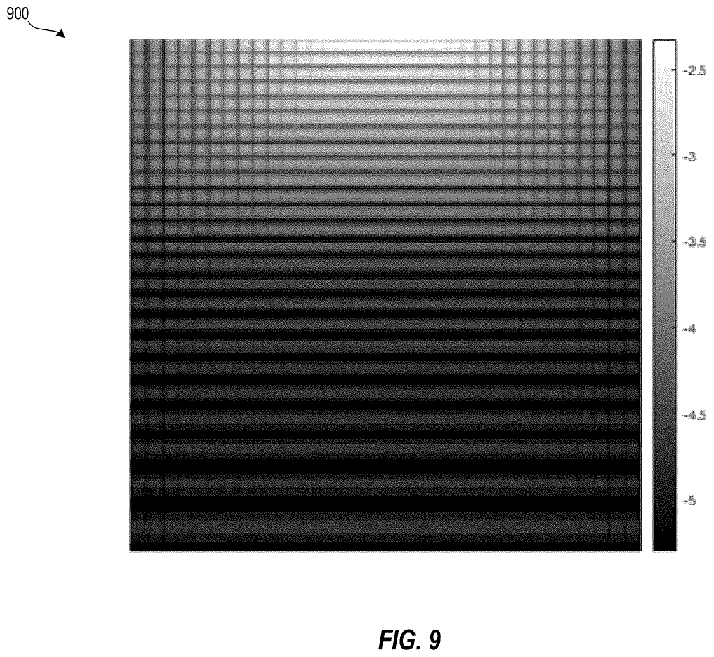

Act 504C of flow diagram 500 includes constructing a 2D scattering metric for the particular sample by combining the FSC angular scattering signal with the SSC angular scattering signal. The FSC angular scattering signal and the SSC angular scattering signal may be combined in various ways to obtain the 2D scattering metric. In one or more examples, the 2D scattering metric is defined via:

$${GFC}_{2 D} = \frac{{FSC}_{θ} \cdot {SSC}_{θ}}{{FSC}_{θ} + {SSC}_{θ}} \qquad ( 1 )$$

where GFC_{2D} represents the 2D scattering metric, FSC_{θ} represents the FSC angular scattering signal, and SSC_{θ} represents the SSC angular scattering signal. The element-wise or dot multiplication of the FSC angular scattering signal with the SSC angular scattering signal (i.e., FSC_{θ}·SSC_{θ}) may form a 2D space, while the total angular scattering may be given by FSC_{θ}+SSC_{θ}. FIG. 8 illustrates an example heat map 800 depicting a 2D space generated by element-wise multiplying the FSC angular scattering signal, FSC_{θ}, with the SSC angular scattering signal, SSC_{θ}, represented in FIG. 7. FIG. 9 illustrates an example heat map 900 depicting an example 2D scattering metric, GFC_{2D}, generated in accordance with Equation 1 using the FSC angular scattering signal, FSC_{θ}, and the SSC angular scattering signal, SSC_{θ}, represented in FIG. 7.

Act 504D of flow diagram 500 of FIG. 5 includes generating a GFC score for the particular sample based on the 2D scattering metric for the particular sample and one or more 2D scattering metrics for one or more other samples of the plurality of samples. The GFC score may be generated or calculated in various ways using the 2D scattering metrics of the particular sample and one or more other samples. In one or more examples, the GFC score is defined via:

$${GFC}_{SV} = \int \int ( {GFC}_{2 D} - 〈 {GFC}_{2 D} 〉 ) dxdy \qquad ( 2 )$$

where GFC_{SV} represents the GFC score (or single-valued GFC metric) for the particular sample, GFC_{2D} represents the 2D scattering metric for the particular sample, and (GFC_{2D}) represents a combination (e.g., average) of 2D scattering metrics for one or more other samples of the plurality of samples. 2D scattering metric(s) associated with the other sample(s) that is/are used to determine the GFC score for the particular sample may be selected in various ways. For instance, where GFC is performed retrospectively (e.g., where a complete set of angular scattering data for each of the plurality of samples is recorded), the GFC score for the particular sample may be determined using the 2D scattering metrics associated with each other sample of the plurality of samples (e.g., (GFC_{2D}) may comprise an average of all 2D scattering metrics for the plurality of samples, excluding or including the particular sample). As another example, where GFC is performed on-the-fly or in real-time (e.g., to gate or sort samples after they pass through the sample plane), the GFC score for the particular sample may be determined using the 2D scattering metrics associated one or more samples from the plurality of samples that passed through the sample plane prior to the particular sample (e.g., (GFC_{2D}) may comprise a running average of 2D scattering metrics for samples that have passed through the sample region).

A GFC score may be obtained for any quantity of samples from the plurality of samples flown through the sample plane of the flow cytometry system, and the GFC scores may be used as a basis for classifying, differentiating, sorting, and/or performing other analysis or actions on the samples of the plurality of samples (see acts 506 and 508).

Act 504E of flow diagram 500 includes capturing a fluorescence signal for the particular sample from the sample plane using one or more photodetectors. Act 504E may be performed when the flow cytometry system includes a set of fluorescence detection optics (e.g., set of fluorescence detection optics 202, see FIG. 2) and one or more photodetectors (e.g., one or more photodetectors 208, see FIG. 2). In at least one or more embodiments, the fluorescence signal(s) for the particular sample may be used when classifying or characterizing the particular sample (see act 506).

Act 504F of flow diagram 500 includes capturing phase information based on (i) reference light directed to the one or more image sensors and (ii) the FSC angular scattering field and/or the SSC angular scattering field. Act 504F may be performed when the flow cytometry system includes a set of reference optics (e.g., set of reference optics 302, see FIG. 3). The set of reference optics may systematically alter the phase of the reference light (e.g., from an input light source that illuminates the sample plane) while recording multiple images at the image sensor(s) that capture the interference pattern between the FSC light and the SSC light. The reference beam may be phase-shifted in controlled steps (e.g., 0°, 90°, 180°, and 270°). The recorded images may contain contributions from both the amplitude and phase of the interfering waves. With multiple images at known phase shifts acquired, the phase information may be isolated (e.g., using a four-step phase shifting algorithm).

Act 504G of flow diagram 500 includes generating a holographic image of the particular sample using the phase information. The phase information discussed above with reference to act 504F may be combined with the recorded amplitude information represented in the captured images to reconstruct the complex optical field of the object wave, providing a reconstructed wavefront with an accurate phase representation. The reconstructed wavefront may be used to generate the holographic image (e.g., a phase or quantitative phase image, a 3D image, a full complex hologram).

Act 506 of flow diagram 500 includes assigning one or more classifications to the plurality of samples or one or more samples thereof based on the GFC score for one or more samples of the plurality of samples. Various techniques may be employed to determine classifications for individual samples or groups of samples from the plurality of samples (or the entire plurality of samples), such as using GFC score thresholds determined using receiver operating characteristic (ROC) analysis. For example, two groups of samples may be defined: one representing the positive class and the other representing the negative class (e.g., based on prior knowledge of the sample set, manual gating, or other validation methods). Once the groups are established, GFC scores may be used as the variable under evaluation. A series of potential threshold values may be selected across the range of GFC scores. For each threshold, sensitivity (true positive rate) and specificity (true negative rate) may be calculated. Sensitivity represents the proportion of positive cells correctly classified above the threshold, while specificity represents the proportion of negative cells correctly classified below the threshold. By systematically varying the threshold, multiple sensitivity-specificity pairs are generated. The resulting sensitivity-specificity pairs may be plotted as a ROC curve, where the x-axis represents the false positive rate (e.g., 1−specificity) and the y-axis represents sensitivity. The ROC curve may illustrate the trade-off between detecting true positives and minimizing false positives. A threshold may be determined from the ROC curve in various ways, such as by maximizing Youden's index (e.g., calculated as sensitivity+specificity−1), selecting the closest point to (0, 1) on the ROC curve, or other methods (e.g., application-specific needs, where high sensitivity or specificity may be favored).

The GFC scores for the various samples of the plurality of samples may be applied to the identified threshold to facilitate classification and/or characterization of the samples. Techniques for classifying samples of the plurality of samples other than ROC analysis may be employed, such as statistical clustering methods, density-based approaches, machine learning models, or manual gating. In some implementations, the classification of the samples of the plurality of samples relies at least in part on captured fluorescence signals (e.g., captured according to act 504E). For example, in one or more embodiments, the data may be input into a machine learning classifier that has been trained in a supervised manner using the same type of input data and corresponding reference labels to classify a sample or samples. Additionally, or alternatively, other machine learning models may be used including semi-supervised and unsupervised methods. In one or more embodiments, an ensemble of two or more methods may be used to determine a final classification. For example, the output of two or more methods may be combined using according to a combination formula, or a voting mechanism may be used. In the case of voting, the classification vote of a model may be weighted (e.g., each model's output may be weighted by its estimated classification probability and/or prior success rate in correctly classifying a sample or samples) or may be unweighted. In unweighted embodiments, the overall system may require a percentage of agreement among models at or above some threshold (e.g., greater than 50%). One skilled in the art shall recognize that a number of ways and systems exists to classify an item given a set of input data.

Act 508 of flow diagram 500 includes sorting each sample of the plurality of samples using the GFC score for each sample of the plurality of samples. For example, the flow cytometry system may include a vibrating nozzle to break the fluid stream into individual droplets, each containing a single sample. A charge electrode may apply an electrical charge to the droplet as it forms, and the polarity of the applied charge may be selected based on the classification determined in accordance with act 506. The charged droplets may then pass through electrostatic deflection plates, which may cause collection of samples at designated collection containers based on charge polarity.

Although the acts described with reference to flow diagram 500 relate to a plurality of samples, the principles disclosed herein may be applied to analysis of any quantity of samples. For instance, in at least one embodiment, a method for performing GFC can comprise (i) flowing a sample through a sample plane of a flow cytometry system; (ii) for the sample: (a) capturing a forward scatter (FSC) angular scattering field from an FSC signal from the sample plane using one or more image sensors, (b) capturing a side scatter (SSC) angular scattering field from an SSC signal from the sample plane using the one or more image sensors, (c) determining an FSC angular scattering signal based on the FSC angular scattering field captured using the one or more image sensors, (d) determining an SSC angular scattering signal based on the SSC angular scattering field captured using the one or more image sensors, (e) constructing a 2D scattering metric for the sample by combining the FSC angular scattering signal with the SSC angular scattering signal, and (f) generating a GFC score for the sample based on the 2D scattering metric for the sample and one or more 2D scattering metrics for one or more other samples; and (iii) assigning one or more classifications to the sample based on the GFC score for the sample. The one or more other samples used to generate the GFC score for the sample may be from the same sample set as the sample or from a different sample set as the sample. For instance, the one or more other samples may comprise previously analyzed samples for which 2D scattering metrics were previously computed (e.g., in accordance with a previous GFC operation or session), and the previously computed 2D scattering metrics may be used to determine the GFC score for the sample (retrospectively or on-the-fly).

Although one or more examples discussed herein focus, in at least some respects, on implementations in which one sample at a time is positioned at the sample plane for analysis using GFC as described herein, GFC may be applied where multiple samples are positioned at the sample plane (e.g., for a homogeneous population of samples, where the presence of multiple samples at the sample plane may boost signal).

### Experiments

It shall be noted that these experiments and results are provided byway of illustration and were performed under specific conditions using a specific embodiment or embodiments; accordingly, neither these experiments nor their results shall be used to limit the scope of the disclosure of the current patent document.

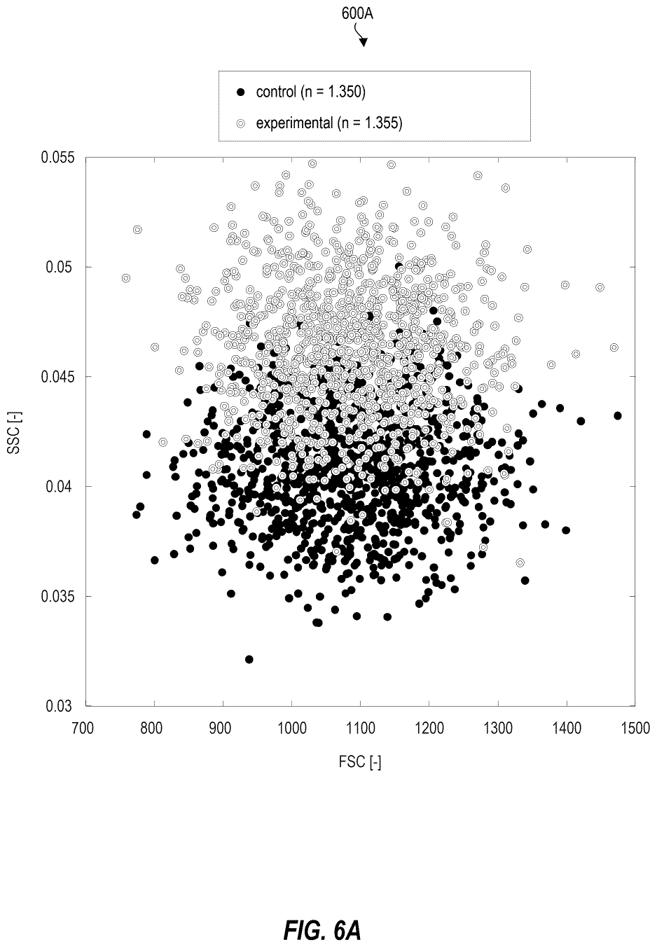

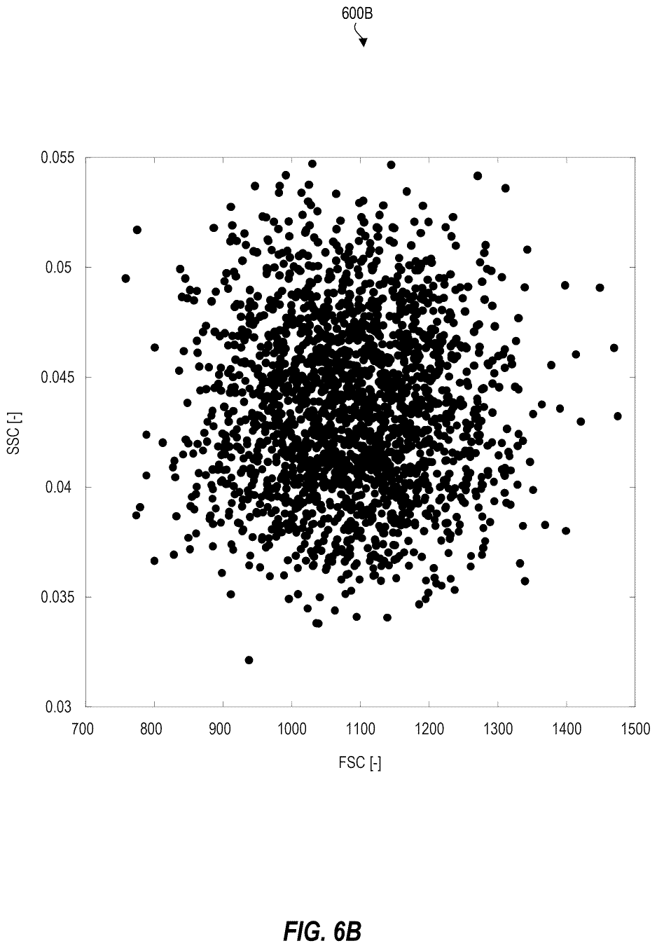

The experiment shown and described with reference to FIGS. 6 through 9 modeled GFC as described herein for a sample set including two types of samples, with the nuclei of the different types of samples having different indices of refraction: n=1.35 and n=1.355 (e.g., within 0.3% of one another), giving both types of samples very similar scatter signals. The nuclei of both types of samples had a diameter of 5 microns. For the GFC modeling/simulation, a numerical aperture of 0.90 was used, providing an angle of acceptance of 64°. The sample set included 1,000 of each type of cell (resulting in 2,000 total samples). Gaussian noise was added to the GFC modeling/simulation to simulate variation in biological samples and experimental implementations. The GFC modeling/simulation used the system configuration shown and described above with reference to FIG. 1.

FIG. 6A illustrates an example scatter plot 600A showing FSC signal vs. SSC signal for a simulation of conventional flow cytometry performed using the sample set. The scatter plot 600A simulates single pixel detection of FSC and SSC signals, as would be performed under conventional flow cytometry techniques (e.g., where angular scatter information is lost). Under conventional flow cytometry techniques, the clustering of the FSC signal vs. SSC signal data may render it difficult to differentiate between the n=1.35 samples and the n=1.355 samples (e.g., without the labeling/differentiation provided in FIG. 6A). For instance, FIG. 6B illustrates a scatter plot 600B illustrating the same FSC signal vs. SSC signal data for the simulation represented in scatter plot 600A, but without different labels/markings for the different cell types. As is evident from FIG. 6B, the close similarity of the cell types in the sample set may result in close clustering of the FSC signal vs. SSC signal data for the sample set, making it difficult to use the FSC signal vs. SSC signal data for cell/sample differentiation.

FIG. 7 illustrates example normalized intensity scattering plots 700A and 700B representing an example FSC angular scattering signal (e.g., FSC_{θ}, see act 504B) and an example SSC angular scattering signal (e.g., SSC_{θ}, see act 504B) for a sample on which GFC as described herein was simulated. The plots 700A and 700B show angular scattering signal along a selected azimuthal angle (e.g., 0°). The FSC angular scattering signal shown in plot 700A is centered on the FSC direction (e.g., 0°), whereas the SSC angular scattering signal shown in plot 700B is centered on the SSC direction (e.g., 90°).

For each sample on which GFC was simulated, the FSC and SSC angular scattering signals were combined to obtain the per-sample 2D scattering metric using Equation (1). FIG. 8 illustrates an example heat map 800 depicting a 2D space for a sample generated by element-wise multiplying the FSC angular scattering signal, FSC_{θ}, with the SSC angular scattering signal, SSC_{θ}, represented in FIG. 7. FIG. 9 illustrates an example heat map 900 depicting an example 2D scattering metric for a sample, GFC_{2D}, generated in accordance with Equation 1 using the FSC angular scattering signal, FSC_{θ}, and the SSC angular scattering signal, SSC_{θ}, represented in FIG. 7. For each sample, the per-sample GFC score was determined using Equation (2). For each sample, the GFC score was calculating using the average of the 2D scattering metrics for all other samples (i.e., (GFC_{2D}) was defined as an average of all 2D scattering metrics for the sample set except for the sample for which the GFC score was being calculated).

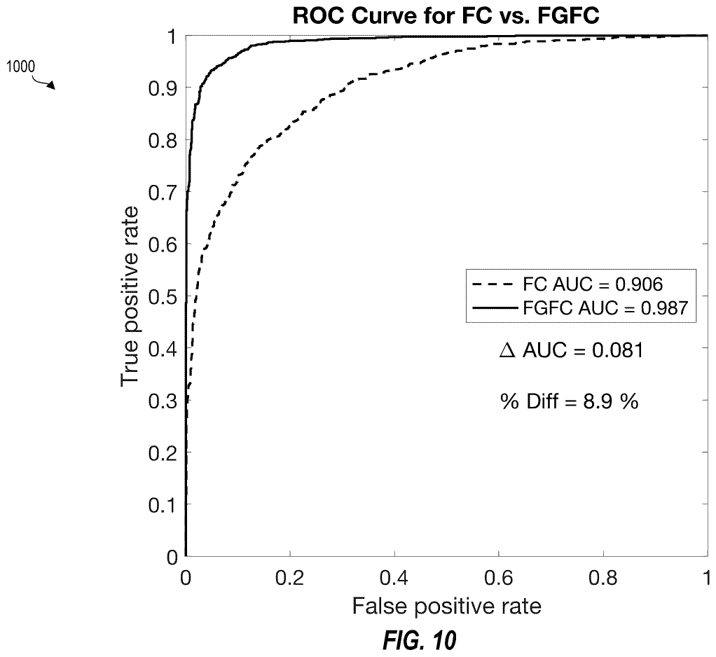

FIG. 10 illustrates a graph 1000 showing ROC curves for the conventional flow cytometry simulation (FC) and the GFC simulation (FGFC) performed using the sample set. The graph 1000 was constructed using techniques described hereinabove with reference to act 506 of flow diagram 500 shown in FIG. 5. As is evident from FIG. 10, the area under the curve (AUC) associated with FGFC (i.e., 0.987) was greater than the AUC associated with conventional flow cytometry (i.e., 0.906), indicating that FGFC resulted in improved classification accuracy.

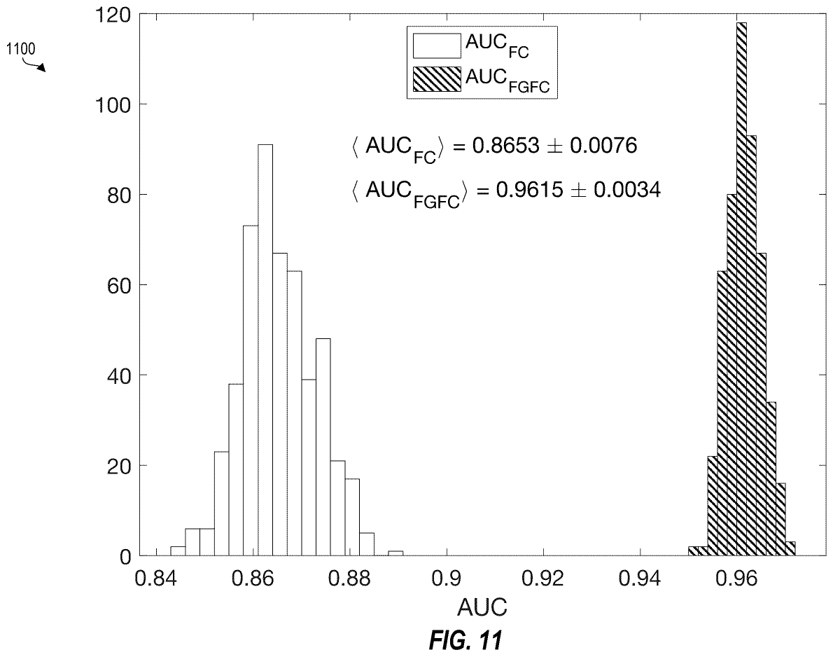

The ROC curves shown in graph 1000 were used to obtain thresholds (using Youden's index) for classifying samples in future FC and GFC simulation iterations with the same sample population characteristics. FIG. 11 illustrates an AUC chart 1100 for 500 iterations of FC simulations and GFC simulations (FGFC), showing the quantity of occurrences of different AUC values for the FC and GFC approaches. As is evident from AUC chart 1100, the GFC approach consistently achieved higher AUC results, indicating a repeatable improvement in accuracy of GFC (and/or FGFC) over conventional flow cytometry analysis techniques.

### Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

FIG. 12 depicts a simplified block diagram of an information handling system (or computing system), according to embodiments of the present disclosure. It will be understood that the functionalities shown for system 1200 may operate to support various embodiments of a computing system—although it shall be understood that a computing system may be differently configured and include different components, including having fewer or more components as depicted in FIG. 12.

As illustrated in FIG. 12, the computing system 1200 includes one or more CPUs 1201 that provide computing resources and control the computer. CPU 1201 may be implemented with a microprocessor or the like and may also include one or more graphics processing units (GPU) 1202 and/or a floating-point coprocessor for mathematical computations. In one or more embodiments, one or more GPUs 1202 may be incorporated within the display controller 1209, such as part of a graphics card or cards. The system 1200 may also include a system memory 1219, which may comprise RAM, ROM, or both.

A number of controllers and peripheral devices may also be provided, as shown in FIG. 12. An input controller 1203 represents an interface to various input device(s) 1204. The computing system 1200 may also include a storage controller 1207 for interfacing with one or more storage devices 1208 each of which includes a storage medium such as magnetic tape or disk, or an optical medium that might be used to record programs of instructions for operating systems, utilities, and applications, which may include embodiments of programs that implement various aspects of the present disclosure. Storage device(s) 1208 may also be used to store processed data or data to be processed in accordance with the disclosure. The system 1200 may also include a display controller 1209 for providing an interface to a display device 1211, which may be a cathode ray tube (CRT) display, a thin film transistor (TFT) display, organic light-emitting diode, electroluminescent panel, plasma panel, or any other type of display. The computing system 1200 may also include one or more peripheral controllers or interfaces 1205 for one or more peripheral devices 1206. Examples of peripherals may include one or more printers, scanners, input devices, output devices, sensors, and the like. A communications controller 1214 may interface with one or more communication devices 1215, which enables the system 1200 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1200 comprises one or more fans or fan trays 1218 and a cooling subsystem controller or controllers 1217 that monitors thermal temperature(s) of the system 1200 (or components thereof) and operates the fans/fan trays 1218 to help regulate the temperature.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize that no computing system or programming language is critical to the practice of the present disclosure. One skilled in the art will also recognize that a number of the elements described above may be physically and/or functionally separated into modules and/or sub-modules or combined together.

It will be appreciated by those skilled in the art that the embodiments described herein are provided by way of example only and are not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claim or claims may be arranged differently including having multiple dependencies, configurations, and combinations.

What is currently claimed is:

1. A Fourier goniometric flow cytometry (FGFC) system, comprising:
a sample flow path configured for flowing one or more samples through a sample plane;
an input light source configured to illuminate the sample plane;
a set of forward scatter (FSC) detection optics configured to direct FSC light from the sample plane to one or more image sensors, wherein the set of FSC detection optics comprises an FSC 4f optical system; and
a set of side scatter (SSC) detection optics configured to direct SSC light from the sample plane to the one or more image sensors, wherein the set of SSC detection optics comprises an SSC 4f optical system.

2. The FGFC system of claim 1, wherein the set of FSC detection optics comprises an FSC objective that is configured to cooperate with the FSC 4f optical system to map an FSC angular scattering field to the one or more image sensors, and wherein the set of SSC detection optics comprises an SSC objective that is configured to cooperate with the SSC 4f optical system to map an SSC angular scattering field to the one or more image sensors.

3. The FGFC system of claim 1, further comprising a condenser configured to direct light from the input light source to the sample plane.

4. The FGFC system of claim 3, further comprising a set of fluorescence detection optics configured to direct a fluorescence signal from the sample plane to one or more photodetectors.

5. The FGFC system of claim 1, further comprising a set of reference optics configured to direct reference light from the input light source to the one or more image sensors such that the reference light does not illuminate the sample plane and such that the reference light illuminates regions of the one or more image sensors that receive the FSC light and the SSC light.

6. A goniometric flow cytometry system, comprising:
a sample flow path configured for flowing one or more samples through a sample plane;
an input light source configured to illuminate the sample plane; and
a set of one or more optics configured to (i) direct forward scatter (FSC) light to one or more image sensors and cause presentation of an FSC angular scattering field from the FSC light at the one or more image sensors and (ii) direct side scatter (SSC) light to the one or more image sensors and cause presentation of an SSC angular scattering field from the SSC light at the one or more image sensors.

7. The goniometric flow cytometry system of claim 6, wherein the FSC angular scattering field and the SSC angular scattering field comprise scattering patterns via far-field diffraction.

8. The goniometric flow cytometry system of claim 6, wherein the FSC angular scattering field and the SSC angular scattering field comprise scattering patterns via near-field diffraction.

9. A method for performing goniometric flow cytometry (GFC), comprising:
flowing a sample through a sample plane of a flow cytometry system;
for the sample:
capturing a forward scatter (FSC) angular scattering field from an FSC signal from the sample plane using one or more image sensors;
capturing a side scatter (SSC) angular scattering field from an SSC signal from the sample plane using the one or more image sensors;
determining an FSC angular scattering signal based on the FSC angular scattering field captured using the one or more image sensors;
determining an SSC angular scattering signal based on the SSC angular scattering field captured using the one or more image sensors;
constructing a 2D scattering metric for the sample by combining the FSC angular scattering signal with the SSC angular scattering signal; and
generating a GFC score for the sample based on the 2D scattering metric for the sample and one or more 2D scattering metrics for one or more other samples; and
assigning one or more classifications to the sample based on the GFC score for the sample.

10. The method of claim 9, wherein the one or more image sensors are positioned to capture the FSC angular scattering field and the SSC angular scattering field at a corresponding Fourier plane.

11. The method of claim 9, wherein determining the FSC angular scattering signal comprises integrating the FSC angular scattering field with respect to azimuthal angle, and wherein determining the SSC angular scattering signal comprises integrating the SSC angular scattering field with respect to azimuthal angle.

12. The method of claim 9, wherein the FSC angular scattering signal is determined using one or more line scans along one or more selected azimuthal angles of the FSC angular scattering field, and wherein the SSC angular scattering signal is determined using one or more line scans along one or more selected azimuthal angles of the SSC angular scattering field.

13. The method of claim 9, wherein the 2D scattering metric comprises a ratio of (i) an element-wise multiplication of the FSC angular scattering signal and the SSC angular scattering signal to (ii) a sum of the FSC angular scattering signal and the SSC angular scattering signal.

14. The method of claim 13, wherein the GFC score for the sample comprises a 2D integral of a difference between (i) the 2D scattering metric for the sample and (ii) an average of the one or more 2D scattering metrics for the one or more other samples.

15. The method of claim 14, wherein the one or more other samples flow through the sample plane of the flow cytometry system prior to the sample.

16. The method of claim 15, further comprising:
sorting the sample using the GFC score for the sample.

17. The method of claim 14, wherein the one or more other samples comprise at least some samples that flow through the sample plane of the flow cytometry system prior to the sample and at least some samples that flow through the sample plane of the flow cytometry system after the sample.

18. The method of claim 9, wherein the one or more classifications are assigned based on one or more GFC score thresholds determined using receiver operating characteristic (ROC) analysis.

19. The method of claim 9, further comprising:
for the sample, capturing a fluorescence signal from the sample plane using one or more photodetectors, wherein the one or more classifications assigned to the sample are further based on captured fluorescence signals.

20. The method of claim 9, further comprising:
for the sample:
capturing phase information based on (i) reference light directed to the one or more image sensors and (ii) the FSC angular scattering field and/or the SSC angular scattering field; and
generating a holographic image of the sample using the phase information.
